(19) United States
(12) Patent Application Publication
(10) Pub. No.: US 2013/0170634 A1
(43) Pub. Date: Jul. 4, 2013

(54) ELECTRONIC DEVICE AND METHOD FOR REDIALING OF ELECTRONIC DEVICE

(71) Applicant: FIH (Hong Kong) Limited, Kowloon (HK)

(72) Inventor: GUAN-CHI WU, New Taipei (TW)

(73) Assignee: FIH (HONG KONG) LIMITED, Kowloon (HK)

(21) Appl. No.: 13/684,624

(22) Filed: Nov. 26, 2012

(30) Foreign Application Priority Data
Dec. 28, 2011 (TW) 100149364

(51) Int. Cl. H04M 3/424

(52) U.S. Cl. CPC H04M 3/424
USPC 379/209.01

(57) ABSTRACT

An electronic device has a function of redialing a telephone number. If a call of the telephone number hangs up, the electronic device detects if the telephone number satisfies a redial condition. If the telephone number is under the redial condition, the telephone number is redialed automatically. If a number of times of the redialing is more than the redial times, the electronic device stops the redialing.

### BACKGROUND

1. Technical Field

Embodiments of the present disclosure relate to electronic device controlling systems and methods, and particularly to an electronic device and a method for activating number redialing of the electronic device.

2. Description of Related Art

Many electronic devices have a dialing function. If a user dials a telephone number, which fails to be answered, the user has to redial the telephone number manually. It is not convenient for the user to redial the telephone number when the user is driving or doing other things.

### BRIEF DESCRIPTION OF THE DRAWINGS

FIG. 1 is a block diagram of one embodiment of an electronic device including a redial system.

FIG. 2 is a block diagram of one embodiment of function modules of the redialing system in FIG. 1.

FIG. 3 is a flowchart illustrating one embodiment of a method for activating number redialing of an electronic device.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

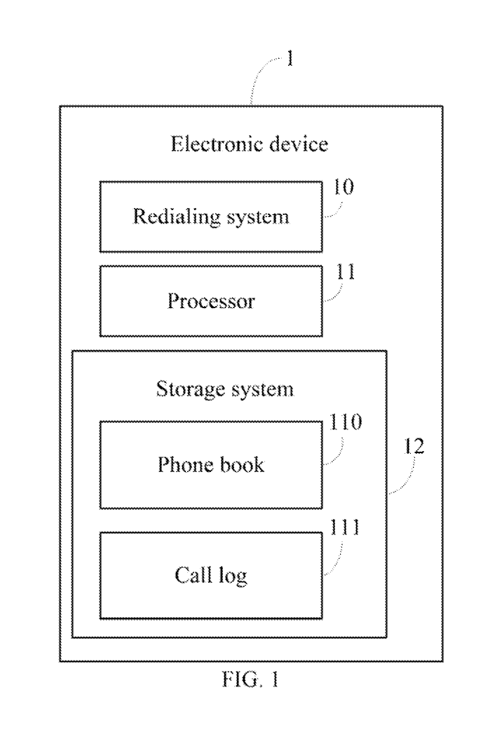

FIG. 1 is a block diagram of one embodiment of an electronic device 1 including a redialing system 10. In some embodiments, the electronic device 1 may be a mobile phone, or a tablet computer, which has a function of making a voice call, for example.

In an exemplary embodiment, the electronic device 1 includes at least one processor 11 and a storage system 12. In one embodiment, the storage system 12 may be a magnetic storage system, an optical storage system, or other suitable storage medium. The storage system 12 stores a phone book 110 and a call log 111. The phone book 110 stores information of contacts. The call log 111 lists records of incoming and outgoing calls.

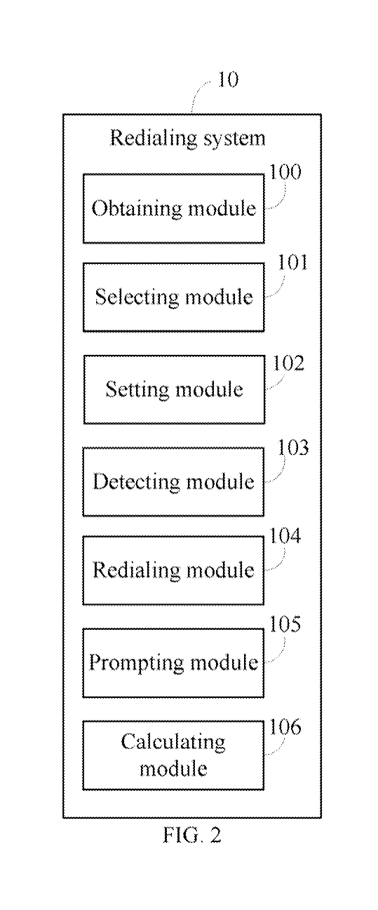

As shown in FIG. 2, the redialing system 10 includes an obtaining module 100, a selecting module 101, a setting module 102, a detecting module 103, a redialing module 104, a prompting module 105, and a calculating module 106. The one or more modules may comprise computerized instructions in the form of one or more programs that are stored in the storage system 12 and executed by the at least one processor 11 to provide functions of the electronic device 1.

The obtaining module 100 obtains all telephone numbers from the phone book 110 and the call log 111. The telephone numbers in the call log 111 may exist in the phone book 110. The telephone numbers in the call log 111 may be listed more than one time. Namely, there are a plurality of telephone numbers which are repeated in the phone book 110 and the call log 111.

The selecting module 101 deletes repetitive telephone numbers and keep one telephone number.

The setting module 102 sets redial parameters of a selected telephone number according to a user's requirement. The setting module 102 may set the redial parameters for one or more telephone numbers at one time. In one embodiment, the redialing parameters may include redialing conditions, a time interval, redialing times, and a remind mode. The redialing conditions may be a phone number that the user dials which fails to be answered, or may be the phone number that the user dials which is busy, or may be the phone number that the user dials is not saved, for example. The time interval is a time between hanging up and redialing the phone number. The redialing times denotes how many times that the phone number needs to be redialed. The remind mode may be a ring mode, a vibration mode, or an indicator light mode.

The detecting module 103 detects whether a call satisfies a condition of the redial conditions if the call is hung up. If the call satisfies a condition of the redial conditions, the redialing module 104 redials the telephone number of the call according to the time interval.

The prompting module 105 prompts the user by using the remind mode and increases the number of times the telephone number is redialed by one. In one embodiment, an initial value of the number of times the telephone number is redialed is zero. The prompting module 105 provides an interface for the user to determine whether the user prefers to redial the telephone number. The user can select redialing the telephone number or cancel redialing of the telephone number.

The calculating module 106 detects whether the number of times the telephone number is redialed is more than the redialing times. If the number of times that the telephone number is redialed is more than the redialing times, the telephone number will not be redialed automatically. If the number of times that the telephone number is redialed is not more than the redialing times, the redialing module 104 redials the telephone number.

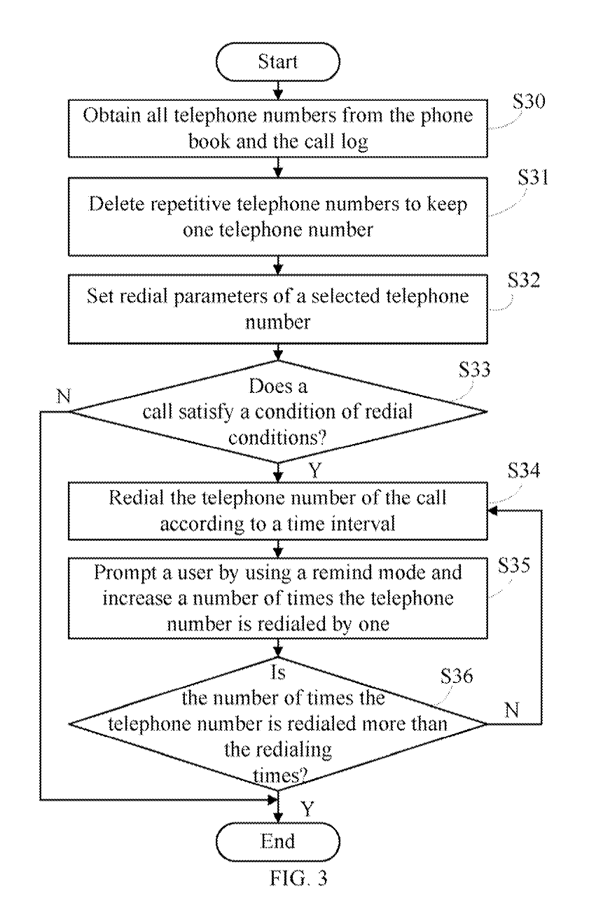

FIG. 3 is a flowchart illustrating a method for activating number redialing of the electronic device 1 in FIG. 1. Depending on the embodiment, additional steps may be increased, others removed, and the ordering of the steps may be changed.

In step S30, the obtaining module 100 obtains all telephone numbers from the phone book 110 and the call log 111.

In step S31, the selecting module 101 deletes repetitive telephone numbers and keep one telephone number.

In step S32, the setting module 102 sets redial parameters of a selected telephone number according to a user's requirement. In one embodiment, the redialing parameters may include redialing conditions, a time interval, redialing times, and a remind mode. The redialing conditions may be a phone number that the user dials which fails to be answered, or may be the phone number that the user dials which is busy, or may be the phone number that the user dials is not in server, for example. The time interval is time between hanging up and redialing the phone number. The redialing times denotes how many times that the phone number needs to be redialed. The remind mode may be a ring mode, a vibration mode, or an indicator light mode.

In step S33, if a call is hung up, the detecting module 103 detects whether a call satisfies a condition of the redial conditions. If the call satisfies the condition of the redial conditions, step S34 is implemented. If the call does not satisfy the condition of the redial conditions, the procedure ends.

In step S34, the redialing module 104 redials the telephone number of the call according to the time interval.

In step S35, the prompting module 105 prompts the user by using the remind mode and increases the number of times that the telephone number is redialed by one. In one embodiment, an initial value of the times of redialing the telephone number is zero.

In step S36, the calculating module 106 detects whether the number of times that the telephone number is redialed is more than the redialing times. If the number of times that the telephone number is redialed is more than the redialing times, the procedure ends. If the number of times that the telephone number is redialed is not more than the redialing times, the procedure goes to step S34.

Although certain inventive embodiments of the present disclosure have been specifically described, the present disclosure is not to be construed as being limited thereto. Various changes or modifications may be made to the present disclosure without departing from the scope and spirit of the present disclosure.

1. An electronic device, comprising:
a storage system;
at least one processor; and
one or more programs stored in the storage system and executed by the at least one processor, the one or more programs comprising:
a setting module that sets redial parameters of a selected telephone number, wherein the redial parameters include redial conditions, a time interval, and a remind mode;
a redialing module that redials the telephone number according to the time interval when a call of the telephone number satisfies a condition of the redial conditions; and
a prompting module that prompts a user that the telephone number is being redialed by using the remind mode.

2. The electronic device as described in claim 1, wherein the one or more programs further comprises:
an obtaining module that obtains all telephone numbers from a phone book and a call log of the electronic device; and
a selecting module that deletes repetitive telephone numbers.

3. The electronic device as described in claim 1, wherein the redialing conditions comprises a phone number that the user called and was unanswered, a phone number that the user calls is busy, and a phone number that the user calls is not in server.

4. The electronic device as described in claim 1, wherein the redial parameters further comprises redial times.

5. The electronic device as described in claim 1, wherein the prompting module further increases the number of times that the telephone number is redialed by one.

6. The electronic device as described in claim 5, wherein the one or more programs further comprise a calculating module that detects whether the number of times that the telephone number is redialed is more than the redialing times.

7. A method being executed by a processor of an electronic device for activating number redialing of the electronic device, comprising:
setting redial parameters of a selected telephone number, wherein the redial parameters include redial conditions, a time interval, and a remind mode;
redialing the telephone number according to the time interval when a call of the telephone number is under a condition of the redial conditions, and
prompting a user that the telephone number is being redialed by using the remind mode.

8. The method as described in claim 7, before the setting step comprising:
obtaining all telephone numbers from a phone book and a call log of the electronic device; and
deleting repetitive telephone numbers.

9. The method as described in claim 7, wherein the redialing conditions comprise a phone number that the user called and was unanswered, a phone number that the user calls is busy, and a phone number that the user calls is not in server.

10. The method as described in claim 7, wherein the redial parameters further comprises redial times.

11. The method as described in claim 7, wherein the prompting step further comprises: increasing a number of times that the telephone number is redialed by one.

12. The method as described in claim 11, further comprising:
detecting whether the number of times that the telephone number is redialed is more than the redialing times;
stopping redialing the telephone number and ending procedure when the number of times that the telephone number is redialed is more than the redialing times; and
executing the redialing step when the number of times that the telephone number is redialed is not more than the redialing time.

13. A non-transitory storage medium having stored thereon instructions that, when executed by a processor, causes the processor to perform a method for activating number redialing of the electronic device, the method comprising:
setting redial parameters of a selected telephone number, wherein the redial parameters include redial conditions, a time interval, and a remind mode;
redialing the telephone number according to the time interval when a call of the telephone number is under a condition of the redial conditions, and
prompting a user that the telephone number is being redialed by using the remind mode.

14. The non-transitory storage medium as described in claim 13, further comprising:
obtaining all telephone numbers from a phone book and a call log of the electronic device; and
deleting repetitive telephone numbers.

15. The non-transitory storage medium as described in claim 13, wherein the redialing conditions comprise a phone number that the user called and was unanswered, a phone number that the user calls is busy, and a phone number that the user calls is not in server.

16. The non-transitory storage medium as described in claim 13, wherein the redial parameters further comprises redial times.

17. The non-transitory storage medium as described in claim 13, wherein the prompting step further comprises: increasing a number of times that the telephone number is redialed by one.

18. The non-transitory storage medium as described in claim 17, further comprising:
detecting whether the number of times that the telephone number is redialed is more than the redialing times;
stopping redialing the telephone number and ending procedure when the number of times that the telephone number is redialed is more than the redialing times; and
executing the redialing step when the number of times that the telephone number is redialed is not more than the redialing time.
